(19) United States
(12) Patent Application Publication
(10) Pub. No.: US 2014/0055392 A1
(43) Pub. Date: Feb. 27, 2014

(54) CARBON NANOTUBE TOUCH PANEL AND TOUCH DISPLAY APPARATUS USING SAME

(71) Applicant: TIANJIN FUNYAUANCHUANG TECHNOLOGY CO., LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,946

(22) Filed: Aug. 22, 2013

(30) Foreign Application Priority Data
Aug. 24, 2012 (CN) 201210304607X

(51) Int. Cl. H01H 1/027; G06F 3/041

(52) U.S. Cl. CPC H01H 1/027; G06F 3/041; B82Y 15/00
USPC 345/173; 200/5 A; 977/956

(57) ABSTRACT

A large-area touch panel utilizing carbon nanotubes (CNT units) includes a first carbon nanotube (CNT) sub-panel and a second CNT sub-panel, the second CNT sub-panel is attached to the second CNT sub-panel to form a single CNT panel assembly. Each of the first CNT sub-panel and the second CNT sub-panel includes a CNT film having a plurality of CNT units, with an orientation of the CNT units in one sub-panel being perpendicular to the CNT units of the other sub-panel.

### CROSS-REFERENCE TO RELATED APPLICATIONS

This application claims all benefits accruing under 35 U.S.C. §119 from China Patent Application No. 201210304607.X, filed on Aug. 24, 2012 in the China Intellectual Property Office, the content of which is hereby incorporated by reference in its entirety. This application is related to commonly-assigned applications entitled, “CARBON NANOTUBE TOUCH PANEL HAVING TWO CARBON NANOTUBE FILMS” filed ______ (Atty. Docket No. US46691), “CARBON NANOTUBE TOUCH PANEL HAVING AT LEAST TWO CARBON NANOTUBE FILMS” filed ______ (Atty. Docket No. US46692), “CARBON NANOTUBE TOUCH PANEL AND METHOD FOR MAKING SAME” filed ______ (Atty. Docket No. US46693), “CARBON NANOTUBE TOUCH PANEL AND TOUCH DISPLAY APPARATUS USING SAME” filed ______ (Atty. Docket No. US46694), “TOUCH PANEL AND TOUCH DISPLAY APPARATUS USING SAME” filed ______ (Atty. Docket No. US46695), and “TOUCH PANEL AND TOUCH DISPLAY APPARATUS USING SAME” filed ______ (Atty. Docket No. US46960).

### BACKGROUND

1. Technical Field

The present disclosure relates to touch sensing technologies, and more particularly, to a touch panel and a carbon nanotube (CNT) touch panel and a touch display apparatus using the CNT touch panel.

2. Description of Related Art

Touch display apparatus normally include a display assembly and a touch panel attached to the display assembly. Carbon nanotube (CNT) touch panels are widely used because of the durability of CNT touch panels. A CNT unit is a carbon nanotube. A CNT touch panel includes a plurality of CNT units arranged in parallel on a substrate; however, conductivity of the CNT unit decreases as a length of the CNT unit increases. This characteristic is a limit in design, and making a CNT touch panel with a large size is problematic.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic view of a touch display apparatus according to a first embodiment of the present disclosure.

FIG. 2 is an exploded view of the touch display apparatus of FIG. 1.

FIG. 3 is a detailed plan view of the touch display apparatus of FIG. 1.

FIG. 4 is a schematic view of a CNT film of the touch display apparatus of FIG. 1.

FIG. 5 is a plan view of a touch display apparatus according to a second embodiment of the present disclosure.

FIG. 6 is a schematic view of a touch display apparatus according to a third embodiment of the present disclosure.

FIG. 7 is a plan view of a touch display apparatus according to a fourth embodiment of the present disclosure.

FIG. 8 is a schematic view of a touch display apparatus according to a fifth embodiment of the present disclosure.

FIG. 9 is a detailed plan view of the touch display apparatus of FIG. 8.

FIG. 10 is a detailed plan view of a touch display apparatus according to a sixth embodiment of the present disclosure.

### DETAILED DESCRIPTION

Reference will be made to the drawings to describe various embodiments.

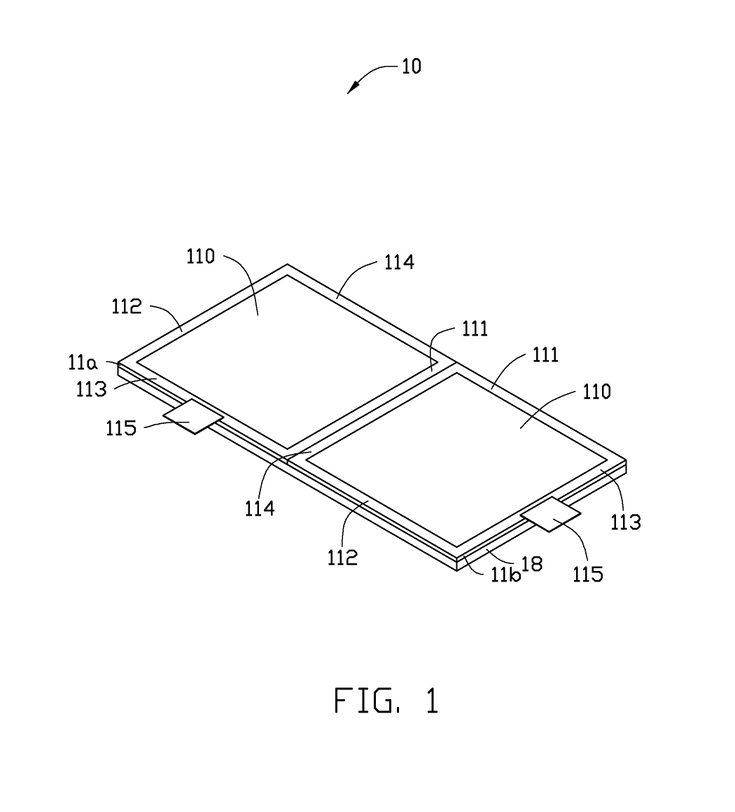

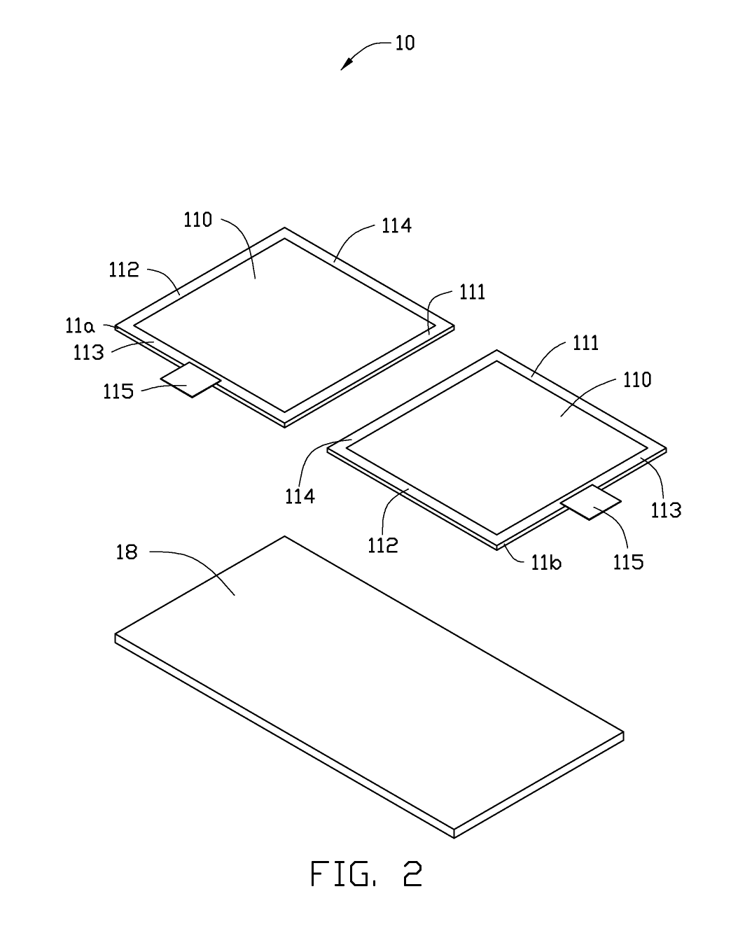

Referring to FIGS. 1-2, a touch display apparatus 10 according to a first embodiment of the present disclosure includes a base 18, a first CNT sub-panel 11a, and a second CNT sub-panel 11b. The base 18 may be a transparent glass substrate or a transparent plastic substrate. The first CNT sub-panel 11a and the second CNT sub-panel 11b are placed on the base 18, for example, the first CNT sub-panel 11a and the second CNT sub-panel 11b may be adhered to the base 18 or be mechanically mounted onto the base 18. In particular, the base 18 may also be a display panel, such as a liquid crystal display (LCD) panel, an organic electro-luminescence display (OLED), a plasma display panel (PDP), for example.

The first CNT sub-panel 11a and the second CNT sub-panel 11b are attached to each other side-by-side, for example, the first CNT sub-panel 11a and the second CNT sub-panel 11b may abut each other to form a single CNT panel assembly, or CNT touch panel. The first CNT sub-panel 11a has a configuration substantially the same as the second CNT sub-panel 11b. Each of the CNT sub-panel 11a and 11b includes a touch sensing region 110, a first side region 111, a second side region 112, a third side region 113, a fourth side region 114, and a flexible printed circuit (FPC) 115. The touch sensing region 110 is located in a main central region of the CNT sub-panel 11a or 11b; the first side region 111, the second side region 112, a third side region 113, and the fourth side region 114 surround the touch sensing region 110, and are arranged end to end to form a periphery of the touch sensing region 110. The FPC 115 is mounted on and electrically connected to an edge of the third side region 113.

The first side region 111 and the second side region 112 are located adjacent to opposite ends of the touch sensing region 110. The third side region 113 and the fourth side region 114 are located adjacent to the other two ends of the touch sensing region 110. In other words, the first side region 111 is opposite to the second side region 112, and is adjacent to the third side region 113 and the fourth side region 114; the second side region 112 is opposite to the first side region 111, and is also adjacent to the third side region 113 and the fourth side region 114; the third side region 113 is opposite to the fourth side region 114, and is adjacent to the first side region 111 and the second side region 112; the fourth side region 114 is opposite to the third side region 113, and is also adjacent to the first side region 111 and the second side region 112.

In the present embodiment, the first CNT sub-panel 11a and the second CNT sub-panel 11b are arranged such that one is oriented at ninety degrees to the other. As such, the fourth side region 114 of the second CNT sub-panel 11b neighbors with and is attached to the first side region 111 of the first CNT sub-panel 11a. Moreover, the first side region 111, the second side region 112, and the third side region 113 are defined as wiring regions, in which connection wires can be formed.

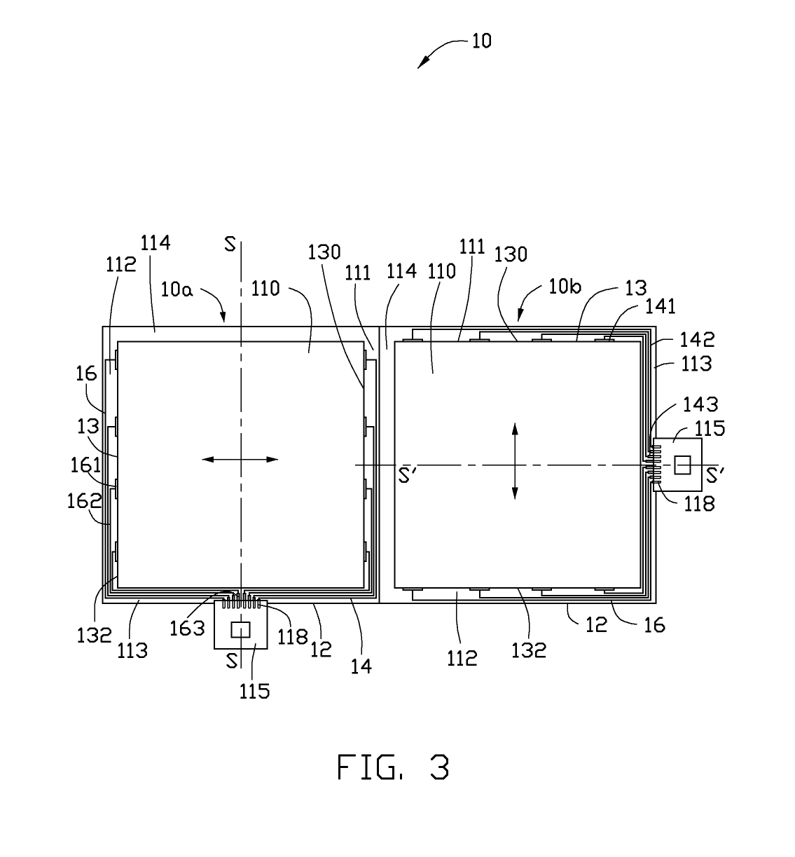

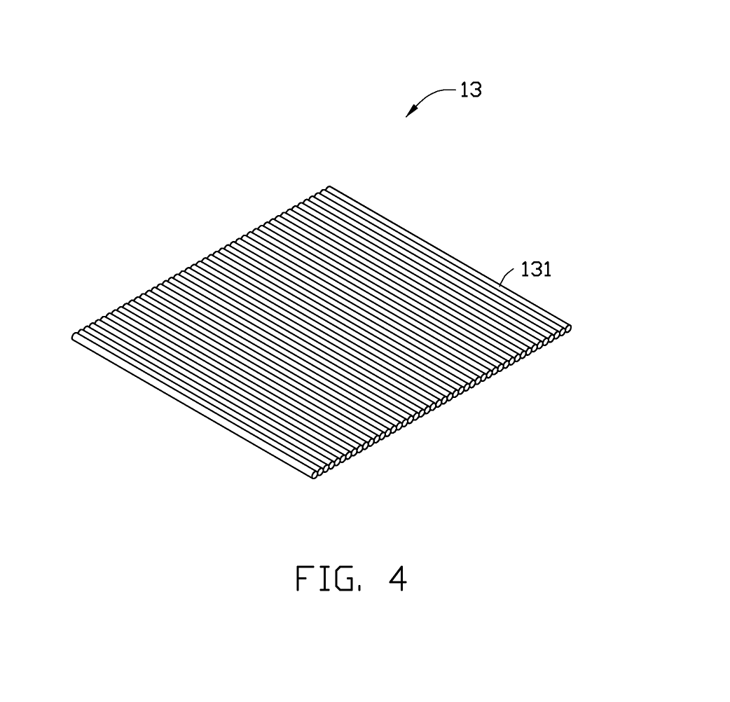

Referring also to FIGS. 3-4, each of the first CNT sub-panel 11a and the second CNT sub-panel 11b includes a substrate 12, a CNT film 13, a plurality of first connection wires 14 and a plurality of second connection wires 16. The CNT film 13, the first connection wires 14, and the second connection wires 16 are formed on the substrate 12. The CNT film 13 covers the touch sensing region 110 of the CNT sub-panels 11a, 11b, and senses touches applied to the touch display apparatus 10 and generates touch signals in accordance with the touches.

As shown in FIG. 4, the CNT film 13 includes a plurality of CNT units 131. The CNT units 131 of the CNT film 13 are arranged parallel to each other. All the CNT units 131 in the CNT film 13 extend from a first end 130 of the CNT film 13 to an opposite second end 132 of the CNT film 13.

The first connection wires 14 and the second connection wires 16 interconnect the CNT film 13 and the FPC 115, and transmit the signals of touches generated by the CNT film 13 to the FPC 115. The first connection wires 14 are formed on the first side region 111 of the CNT sub-panels 11a or 11b, and extend onto the third side region 113 of the CNT sub-panels 11a or 11b in order to connect with the FPC 15. The second connection wires 16 are formed on the second side region 112 of the CNT sub-panel 11a or 11b, and also extend onto the third side region 113 of the CNT sub-panel 11a or 11b in order to connect with the FPC 15. In the present embodiment, the first connection wires 14 and the second connection wires 16 of the first CNT sub-panel 11a are substantially symmetrical along an axis of symmetry S-S (see FIG. 3); the first connection wires 14 and the second connection wires 16 of the second CNT sub-panel 11b are substantially symmetrical along an axis of symmetry S′-S′ (see FIG. 3). The axis of symmetry S-S is perpendicular to the orientation of the CNT units 13 in the first CNT sub-panel 11a, and the axis of symmetry S′-S′ is perpendicular to the orientation of the CNT units 13 in the second CNT sub-panel 11b.

In particular, each of the first connection wires 14 includes a first electrode 141, a first wire body 142, and a second electrode 143. The first electrode 141 is electrically connected to an end of the first wire body 142, and is attached to the first end 130 of the CNT film 13; the second electrode 143 is electrically connected to the other end of the first wire body 142. Each of the second connection wires 16 includes a third electrode 161, a second wire body 162 and a fourth electrode 163. The third electrode 161 is electrically connected to an end of the second wire body 162, and is attached to the second end 132 of the CNT film 13; the fourth electrode 163 is electrically connected to the other end of the second wire body 162. The second electrodes 143 and the fourth electrodes 163 are arranged in parallel at a central edge of the third side region 113.

The FPC 115 includes a plurality of connection electrodes 118 all of which are arranged in parallel, and each of the connection electrodes 118 is attached to one of the second electrodes 143 or one of the fourth electrodes 163. The attachment between the connection electrodes 118 and the electrodes 143, 163 enables transmission of the touch signals to the FPC 115.

When the touch display apparatus 10 is in operation, the CNT film 13 may generate touch signals in response to touches applied thereto, and the touch signals may be transmitted to the FPC 115 via the first connection wires 14 and the second connections wires 16, and then be received by a processing unit to determine coordinates of the touches.

In the foregoing touch display apparatus 10, the touch panel is formed by the two CNT sub-panels 11a and 11b being attached to each other, thus large-sized touch panels can be created without the need of growing or creating very long CNT units. As such, the functions of the touch display apparatus 10 as provided in the present embodiment are equal to those of a larger touch display apparatus.

Moreover, because the orientation of CNT units 131 in the CNT film 13 of the first CNT sub-panel 11a is perpendicular to the orientation of the CNT units 131 in the CNT film 13 of the second CNT sub-panel 11b, the first CNT sub-panel 11a can be attached to the second CNT sub-panel 11b along the orientation of CNT units 131 in the CNT film 13 of the second CNT sub-panel 11b, this maintains the necessary overall conductivity of the touch panel.

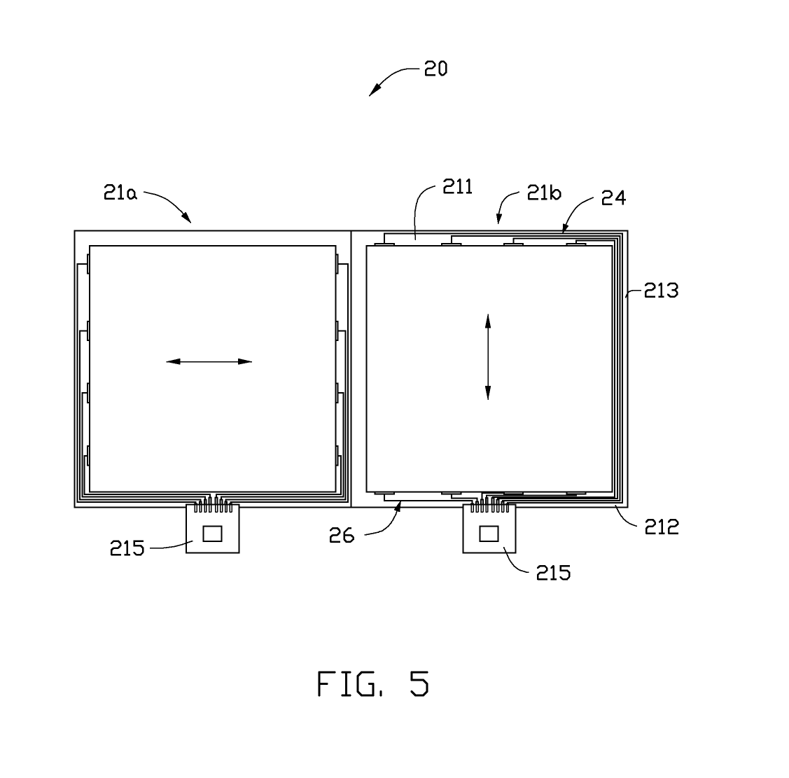

Referring to FIG. 5, a touch display apparatus 20 according to a second embodiment of the present disclosure is similar to the above-described touch display apparatus 10 according to the first embodiment, but differs in the following aspects. An FPC 215 of a second CNT sub-panel 21b is mounted onto a second side region 112 of the second CNT sub-panel 21b. In the second CNT sub-panel 21b, a plurality of first connection wires 24 is formed at a first side region 211, extending through a third side region 213, and on reaching the second side region 212, are electrically connected to the FPC 215; moreover, a plurality of second connection wires 26 is formed at the second side region 212 and are electrically connected to the FPC 215. With this configuration, the FPC 215 in the second CNT sub-panel 21b is adjacent to an FPC 215 in a first sub-panel 21a, this facilitates a connection between the two FPCs 215 and a main circuit board (not shown); furthermore, the two FPCs 215 may be alternatively integrated into a single unit.

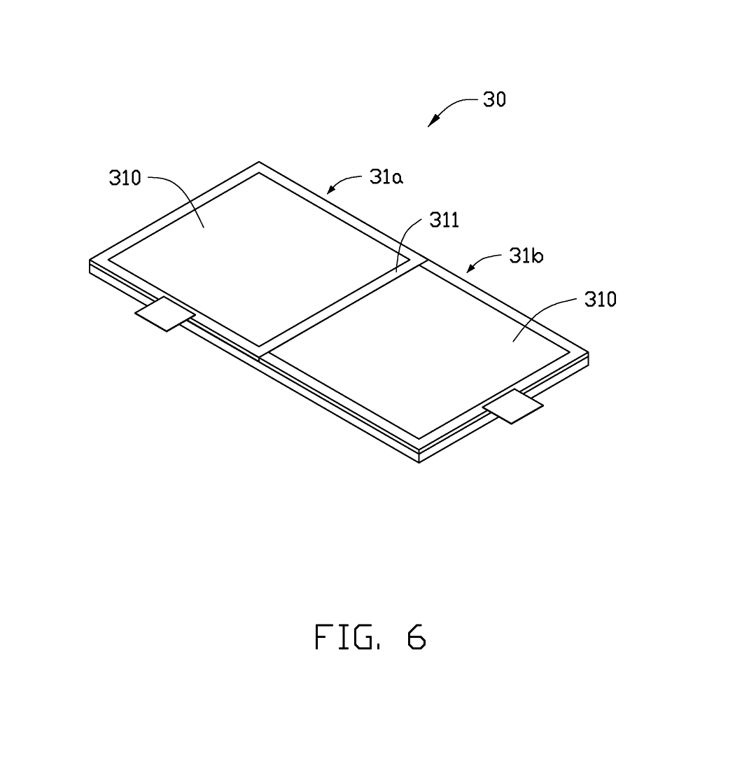

Referring to FIG. 6, a touch display apparatus 30 according to a third embodiment of the present disclosure is similar to the above-described touch display apparatus 10 according to the first embodiment, but differs in the following aspects: a second CNT sub-panel 31b of the touch display apparatus 30 does not include a fourth side region, and instead, a touch sensing region 310 of the second CNT sub-panel 31b is directly attached to a first side region 311 of the first CNT sub-panel 31a. With this configuration, a touch-insensitive gap between the touch sensing regions 310 of the first and second CNT sub-panels 31a and 31b can be narrower.

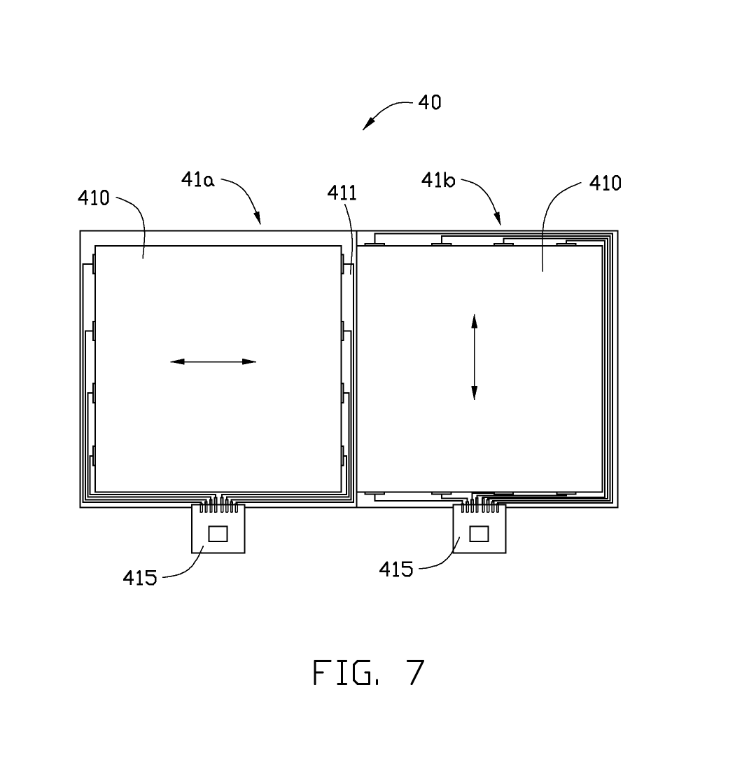

Referring to FIG. 7, a touch display apparatus 40 according to a fourth embodiment of the present disclosure is similar to the above-described touch display apparatus 10 according to the first embodiment, but differs in the following aspects: an FPC 415 in a second CNT sub-panel 41b is mounted adjacent to an FPC 415 in a first sub-panel 41a; in addition, a second CNT sub-panel 41b of the touch display apparatus 40 does not include a fourth side region, instead, a touch sensing region 410 of the second CNT sub-panel 41b is directly attached to a first side region 411 of the first CNT sub-panel 41a.

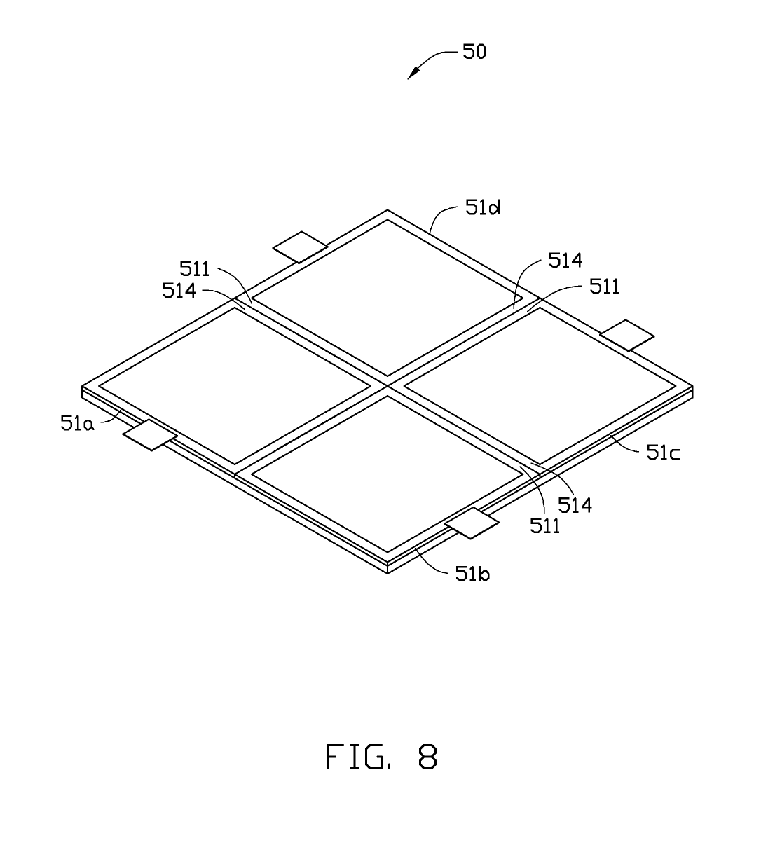

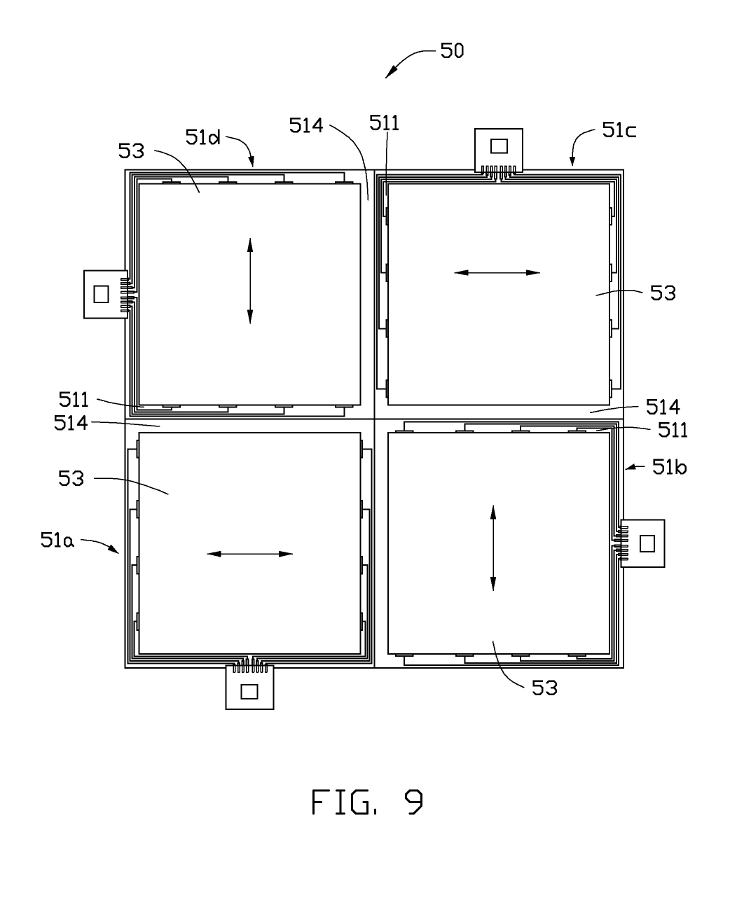

Referring to FIGS. 8-9, a touch display apparatus 50 according to a fifth embodiment of the present disclosure is similar to the above-described touch display apparatus 10 according to the first embodiment, but differs in the following aspects: in addition to a first CNT sub-panel 51a and a second CNT sub-panel 51b, the touch display apparatus 50 further includes a third CNT sub-panel 51c and a fourth CNT sub-panel 51d. Configurations of the first CNT sub-panel 51a, the second CNT sub-panel 51b, the third CNT sub-panel 51c and the fourth CNT sub-panel 51d remain substantially the same. The first CNT sub-panel 51a, the second CNT sub-panel 51b, the third CNT sub-panel 51c and the fourth CNT sub-panel 51d are arranged anticlockwise as a two-plus-two sub-panel array, and two adjacent CNT sub-panels are attached to each other side-by-side to form a single CNT panel assembly.

In the touch display apparatus 50, the second CNT sub-panel 51b is oriented at ninety degrees relative to the first CNT sub-panel 11a, the third CNT sub-panel 51c is oriented at one hundred and eighty degrees relative to the first CNT sub-panel 11a, and the fourth CNT sub-panel 51d is oriented at two hundred and seventy degrees relative to the first CNT sub-panel 11a. Accordingly, a first side region 511 of the fourth CNT sub-panel 51d is the neighbor of, and is attached to, a fourth side region 514 of the first CNT sub-panel 51a. A fourth side region 514 of the third CNT sub-panel 51c is the neighbor of, and attached to, a first side region 511 of the second CNT sub-panel 51b, and a first side region 511 of the third CNT sub-panel 51c is the neighbor of, and attached to, a fourth side region 514 of the fourth CNT sub-panel 51d.

Moreover, an orientation of CNT units in a CNT film 53 of the second CNT sub-panel 51b is perpendicular to an orientation of the CNT units of the first CNT-panel 51a. An orientation of CNT units in a CNT film 53 of the third CNT sub-panel 51c is parallel to the orientation of the CNT units of the first CNT-panel 51a, and an orientation of CNT units in a CNT film 53 of the fourth CNT sub-panel 51d is perpendicular to the orientation of the CNT units of the first CNT-panel 51a.

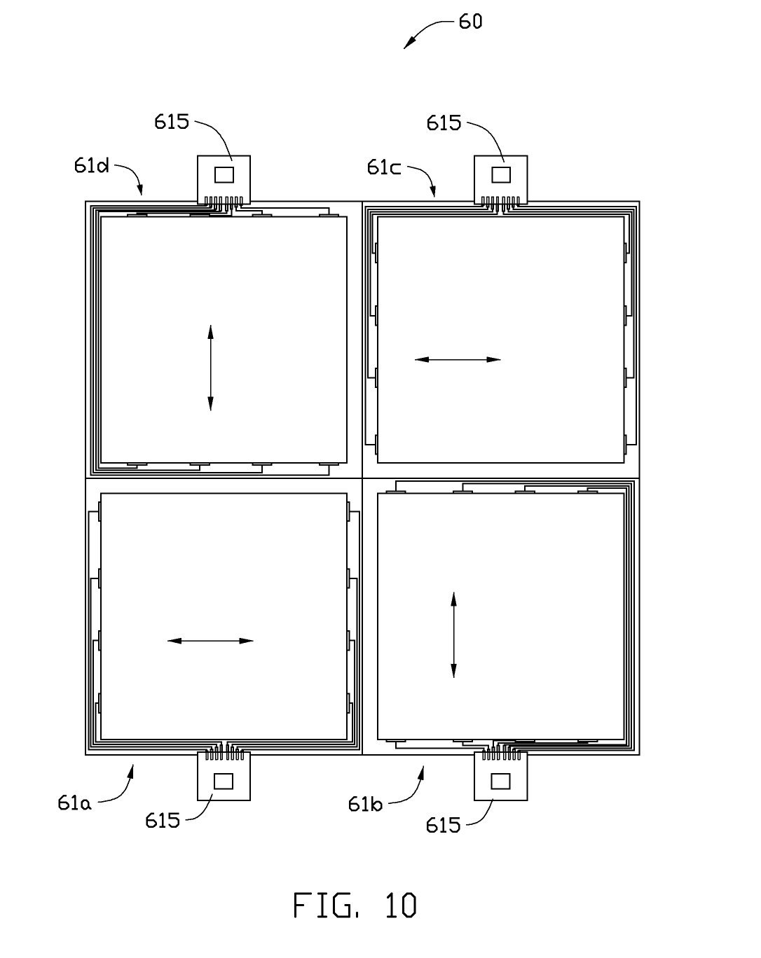

Referring to FIG. 10, a touch display apparatus 60 according to a sixth embodiment of the present disclosure is similar to the above-described touch display apparatus 50 according to the fifth embodiment, but differs in the following aspects: an FPC 615 in a second CNT sub-panel 61b is mounted adjacent to an FPC 415 in a first sub-panel 61a, and an FPC 615 in a fourth CNT sub-panel 61d is mounted adjacent to an FPC 415 in a third sub-panel 61c.

It is to be understood that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts, within the principles of the embodiments, to the full extent indicated by the broad general meaning of the terms in which the appended claims are expressed.

What is claimed is:

1. A carbon nanotube (CNT) touch panel, comprising:
a first CNT sub-panel; and
a second CNT sub-panel attached to the second CNT sub-panel to form a single CNT panel assembly;
wherein each of the first CNT sub-panel and the second CNT sub-panel comprises a CNT film having a plurality of CNT units, and an orientation of the CNT units in one CNT sub-panel is perpendicular to the CNT units of the other CNT sub-panel.

2. The CNT touch panel of claim 1, wherein each of the first CNT sub-panel and the second CNT sub-panel comprises a touch sensing region, a first side region, a second side region and a third side region; the CNT film covers the touch sensing region; the first side region, the second side region and the third region surround the touch sensing region and are defined as wiring regions; wherein the first side region is opposite to the second side region, and the third side region is adjacent to the first side region and the second side region.

3. The CNT touch panel of claim 2, wherein each of the first CNT sub-panel and the second CNT sub-panel comprises a flexible printed circuit, a plurality of first connection wires and a plurality of second connection wires; the first connection wires interconnect a first end of the CNT film and the flexible printed circuit, the second connection wires interconnect an opposite second end of the CNT film and the flexible printed circuit.

4. The CNT touch panel of claim 3, wherein the flexible printed circuit is mounted on the third side region, the first connection wires are formed on the first side region and extend onto the third side region to connect the flexible printed circuit, the second connection wires are formed on the second side region and extend onto the third side region to connect the flexible printed circuit.

5. The CNT touch panel of claim 3, wherein the flexible printed circuit of the first CNT sub-panel is mounted on the third side region of the first CNT sub-panel, and the flexible printed circuit of the second CNT sub-panel is mounted on the second side region of the first CNT sub-panel.

6. The CNT touch panel of claim 2, wherein each of the first CNT sub-panel and the second CNT sub-panel further comprises a fourth side region opposite to the third side region, and the first side region of the first CNT sub-panel neighbors with and is attached to the fourth side region of the second CNT sub-panel.

7. The CNT touch panel of claim 2, wherein the first CNT sub-panel further comprises a fourth side region opposite to the third side region, and the first side region of the first CNT sub-panel neighbors with and is attached to the touch sensing region of the second CNT sub-panel.

8. The CNT touch panel of claim 5, wherein the first CNT sub-panel further comprises a fourth side region opposite to the third side region, and the first side region of the first CNT sub-panel neighbors with and is attached to the touch sensing region of the second CNT sub-panel.

9. The CNT touch panel of claim 1, further comprising a third CNT sub-panel and a fourth CNT sub-panel, wherein the first CNT sub-panel, the second CNT sub-panel, the third CNT sub-panel and the fourth CNT sub-panel are arranged anticlockwise as a two-plus-two sub-panel array, and two adjacent CNT sub-panels are attached to each other side-by-side to form a single CNT panel assembly.

10. The CNT touch panel of claim 9, wherein each of the first CNT sub-panel, the second CNT sub-panel, the third CNT sub-panel and the fourth CNT sub-panel comprises a flexible printed circuit; the flexible printed circuit of the first CNT sub-panel is mounted adjacent to the flexible printed circuit of the second CNT sub-panel, and the flexible printed circuit of the third CNT sub-panel is mounted adjacent to the flexible printed circuit of the fourth CNT sub-panel.

11. A touch display apparatus, comprising:
a display panel;
a first carbon nanotube (CNT) sub-panel; and
a second CNT sub-panel;
wherein the first CNT sub-panel and the second CNT sub-panel are placed on the display panel, and the first CNT sub-panel is attached to the second CNT sub-panel to form a single CNT panel assembly;
wherein each of the first CNT sub-panel and the second CNT sub-panel comprises a CNT film having a plurality of CNT units, and an orientation of the CNT units in one CNT sub-panel is perpendicular to the CNT units of the other CNT sub-panel.

12. The touch display apparatus of claim 11, wherein each of the first CNT sub-panel and the second CNT sub-panel comprises a touch sensing region, a first side region, a second side region and a third side region; the CNT film covers the touch sensing region; the first side region, the second side region and the third region surround the touch sensing region and are defined as wiring regions; wherein the first side region is opposite to the second side region, and the third side region is adjacent to the first side region and the second side region.

13. The touch display apparatus of claim 12, wherein each of the first CNT sub-panel and the second CNT sub-panel comprises a flexible printed circuit, a plurality of first connection wires and a plurality of second connection wires; the first connection wires interconnect a first end of the CNT film and the flexible printed circuit, the second connection wires interconnect an opposite second end of the CNT film and the flexible printed circuit.

14. The touch display apparatus of claim 13, wherein the flexible printed circuit is mounted on the third side region, the first connection wires are formed on the first side region and extend onto the third side region to connect the flexible printed circuit, the second connection wires are formed on the second side region and extend onto the third side region to connect the flexible printed circuit.

15. The touch display apparatus of claim 13, wherein the flexible printed circuit of the first CNT sub-panel is mounted on the third side region of the first CNT sub-panel, and the flexible printed circuit of the second CNT sub-panel is mounted on the second side region of the first CNT sub-panel.

16. The touch display apparatus of claim 12, wherein each of the first CNT sub-panel and the second CNT sub-panel further comprises a fourth side region opposite to the third side region, and the first side region of the first CNT sub-panel neighbors with and is attached to the fourth side region of the second CNT sub-panel.

17. The touch display apparatus of claim 12, wherein the first CNT sub-panel further comprises a fourth side region opposite to the third side region, and the first side region of the first CNT sub-panel neighbors with and is attached to the touch sensing region of the second CNT sub-panel.

18. The touch display apparatus of claim 15, wherein the first CNT sub-panel further comprises a fourth side region opposite to the third side region, and the first side region of the first CNT sub-panel neighbors with and is attached to the touch sensing region of the second CNT sub-panel.

19. The touch display apparatus of claim 11, further comprising a third CNT sub-panel and a fourth CNT sub-panel placed on the display panel, wherein the first CNT sub-panel, the second CNT sub-panel, the third CNT sub-panel and the fourth CNT sub-panel are arranged anticlockwise as a two-plus-two sub-panel array, and two adjacent CNT sub-panels are attached to each other side-by-side to form a single CNT panel assembly.

20. The touch display apparatus of claim 19, wherein each of the first CNT sub-panel, the second CNT sub-panel, the third CNT sub-panel and the fourth CNT sub-panel comprises a flexible printed circuit; the flexible printed circuit of the first CNT sub-panel is mounted adjacent to the flexible printed circuit of the second CNT sub-panel, and the flexible printed circuit of the third CNT sub-panel is mounted adjacent to the flexible printed circuit of the fourth CNT sub-panel.
